(19) United States
(12) Patent Application Publication
(10) Pub. No.: US 2025/0260658 A1
(43) Pub. Date: Aug. 14, 2025

(54) AI-BASED COMMUNICATION SYSTEMS AND METHODS FOR PROPERTY MANAGEMENT

(71) Applicant: Entrata, Inc., Lehi, UT (US)

(72) Inventor: Ethan BAHIR, Petach Tikva (IL)

(21) Appl. No.: 19/049,788

(22) Filed: Feb. 10, 2025

Related U.S. Application Data
(60) Provisional application No. 63/551,231, filed on Feb. 8, 2024.

(51) Int. Cl. H04L 51/04; G06Q 30/0645; G06Q 50/163

(52) U.S. Cl. CPC H04L 51/04; G06Q 30/0645; G06Q 50/163

(57) ABSTRACT

Systems and methods are provided for improving communication with residents, increasing the effectiveness of rent collection and reducing eviction rates, by extensive implementation of machine learning within a structured correspondence model. Resident data is analyzed and used to derive message sequences, which form the skeleton for communicating with the residents. Based on the sequences, communication is carried out using interactive conversational and/or generative AI (artificial intelligence), to resolve raised issues and settle irregularities by continuous machine learning. In application, disclosed systems and methods were able to increase the efficiency of human-based communication systems and the rate of conflict resolution by at least a third.

### CROSS REFERENCE

The present Application for Patent claims the benefit of U.S. Provisional Patent Application No. 63/551,231 by BAHIR, entitled “AI-BASED COMMUNICATION SYSTEMS AND METHODS FOR PROPERTY MANAGEMENT”, filed Feb. 8, 2024, which is assigned to the assignee hereof, and is expressly incorporated by reference herein.

### BACKGROUND

The present invention relates to the field of communication systems, and more particularly, to AI (artificial intelligence)-based communication systems.

Property management companies handle many properties and the residents that rent the properties. It is not uncommon for a single property manager to simultaneously manage hundreds or thousands of properties (e.g., multi-family and single family residences) and hundreds or thousands of residents. Handling so many matters is very complicated in terms of payment collection, and typically includes a single payment directive that defines a due date, a grace period and an intermediate late fee period (typically with surcharge). In case of non-payment, legal proceedings may be initiated, either to collect debts from leaving residents or to evict non-paying residents that remain in the property. For example, a common renting practice includes a due date falling on the 1st day of each month, a grace period ending on the 5th day of the month, a late fee period beginning on the 6th day of the month and ending on the 15th day of the month, and further handling begins on the 16th day of each month if payment was not made. Such a common directive is stringent and is respected by authorities of most US states that strictly enforce eviction when no payment is made. In some cases, property management companies offer payment plans to residents, or allow residents delay their payments for several days beyond the determined dates-which make the handling of the properties even more complicated, as it requires specific follow-ups for each resident. It is noted that there are many reasons that may cause residents not to pay their rent on time or not to pay at all, some of which objective, others personal, which may be acceptable to the property management company, but requiring additional handling beyond the defined regular flow.

Accordingly, the collection of rent is concentrated within short and limited periods (e.g., the first five days of the grace period and the following ten days of the late fee period), and is typically done month by month, with more than half the payments done manually (not online), and with many residents requiring specific consideration. During the grace and late fee periods, property managers traditionally call or send individually-drafted messages to the residents to remind them of the situation's consequences. Some property managers even use the traditional practice of leaving individual notes on the residents' doors.

In addition to human-based communication (involving knocking on doors, making phone calls, and sending notices and emails to anyone due on their rent), automated communication systems are used to provide rent collection alerts (e.g., PMSs—Property management software, or in general CRMs—Customer relationship management systems), but still require the property manager to call or message separately with each exceptional resident, usually by tailoring a message for that resident to be specific-which is tedious, time-consuming, and inefficient. Commonly, conflicts and misunderstandings are not resolved in the proper time and way, and may lead to residents not paying the rent, legal proceedings and evictions, causing much discomfort and revenue loss due to lack of efficiency.

For example, according to NMHC (National Multifamily Housing Council) data (https://www.nmhc.org/research-insight/nmhc-rent-payment-tracker, based on more than eleven million apartment units), and depending on the type of property and socio-economic parameters of the residents, each month about 20% of the residents are typically late in rent payments and about 5% of the residents who do not pay rent at all (leaving the property or requiring eviction). Such high rates of late payment require substantial human input and result in crucial and urgent monthly communication with the late paying residents.

Automated collection does not solve these issues, which are the main load on property management companies, as late payment involves both financial and legal aspects and as communicating with the residents requires a high level of responsibility and attentiveness to specific needs and constraints, while heeding all the legal aspects associated with managements of properties and residents.

### SUMMARY

The following is a simplified summary providing an initial understanding of the invention. The summary does not necessarily identify key elements nor limit the scope of the invention, but merely serves as an introduction to the following description.

One aspect of the present invention provides an AI (artificial intelligence)-based system for communicating with residents with respect to rent collection, the system comprising: an analysis unit configured to access a database of a property management company and to analyze payment records associated with managed residents and derive payment behaviors of the residents, a message sequencing unit configured to derive corresponding message sequences related to the derived payment behaviors, and with respect to a specified collection timeline and specified collection rules, and an AI-based interactive message generator configured to send messages and to correspond with the residents to promote rent payments—according to the derived message sequences and with respect to responses received from the residents, wherein the derived message sequences and the interactive messaging are specific to individual residents, and wherein the system is configured to communicate with at least hundreds or thousands of residents simultaneously.

One aspect of the present invention provides a computer program product comprising a non-transitory computer readable storage medium having computer readable program embodied therewith, the computer readable program comprising: computer readable program configured to access a database of a property management company, analyze payment records associated with managed residents and derive payment behaviors of the residents, computer readable program configured to derive corresponding message sequences related to the derived payment behaviors, and with respect to a specified collection timeline and specified collection rules, and computer readable program configured to send messages and to correspond interactively with the residents to promote rent payments—according to the derived message sequences and with respect to responses received from the residents, wherein the derived message sequences and the interactive messaging are specific to individual residents.

One aspect of the present invention provides a system comprising a storage device and a processor coupled to the storage device, the storage device storing software instructions for controlling the processor that when executed configures the processor to: analyze payment records associated with managed residents and derive payment behaviors of the residents, derive corresponding message sequences related to the derived payment behaviors, and with respect to a specified collection timeline and specified collection rules, and send messages and correspond interactively with the residents to promote rent payments—according to the derived message sequences and with respect to responses received from the residents, wherein the derived message sequences and the interactive messaging are specific to individual residents.

One aspect of the present invention provides an AI-based method of communicating with residents with respect to rent collection, the method comprising: analyzing payment records associated with managed residents and deriving payment behaviors of the residents, deriving corresponding message sequences related to the derived payment behaviors, and with respect to a specified collection timeline and specified collection rules, and sending messages and interactively corresponding with the residents to promote rent payments—according to the derived message sequences and with respect to responses received from the residents, wherein the derived message sequences and the interactive messaging are specific to individual residents, and wherein the method is carried out to communicate with at least hundreds or thousands of residents simultaneously

One aspect of the present invention provides a method of improving rent collection by a property management company and reducing evictions of residents managed thereby, the method comprising: analyzing payment records associated with the managed residents and deriving payment behaviors of the residents, deriving corresponding message sequences related to the derived payment behaviors, and with respect to a specified collection timeline and specified collection rules, and sending messages and corresponding interactively with the residents to promote rent payments—according to the derived message sequences and with respect to responses received from the residents, wherein the derived message sequences and the interactive messaging are specific to individual residents, and wherein rent collection is increased and eviction rate is decreased by tailoring the correspondence to the deriving payment behaviors of the residents and to the responses received from the residents.

One aspect of the present invention provides a method of using AI (artificial intelligence) to improve a rent collection system, the method comprising: training and implementing an interactive message generator to correspond with residents in respect to rent collection by a property management company, by: engaging the residents according to predefined message sequences, derived with respect to payment behaviors by the individual residents, and with respect to a specified collection timeline and specified collection rules, corresponding with the residents implementing AI to promote rent collection according to the predefined message sequences and with respect to responses received from the residents, using AI to derive insights and scoring concerning the residents and alerting the property management company in cases of non-payment, and deriving AI-based decisions, optionally assisted by human guidance, concerning resolution of payment conflicts, to increase rent collection and reducing resident evictions, wherein AI training is carried out at least partially by at least one computer processor.

These, additional, and/or other aspects and/or advantages of the present invention are set forth in the detailed description which follows, possibly inferable from the detailed description, and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout. In the accompanying drawings:

FIGS. 1A and 1B are high-level schematic block diagrams of systems for communicating with residents with respect to rent collection, according to some embodiments of the invention.

FIGS. 2A and 2B are high-level schematic illustrations of non-limiting examples for communication flows with residents, according to some embodiments of the invention.

FIGS. 2C and 2D provide schematic non-limiting examples for improvements in efficiency and in communication, according to some embodiments of the invention.

FIGS. 3A and 3B are high-level flowcharts illustrating methods, according to some embodiments of the invention.

FIG. 4 is a high-level block diagram of exemplary controllers, which may be used with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing”, “deriving” or the like, ref er to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Some embodiments of the present invention provide efficient and economical methods and mechanisms for improved communication, enhanced by AI, and thereby provide improvements to the technological field of AI-based communication systems. Systems and methods are provided for improving communication with residents, increasing the effectiveness of rent collection and reducing eviction rates, by extensive implementation of machine learning within a structured correspondence model. Resident data is analyzed and used to derive message sequences, which form the skeleton for communicating with the residents. Based on the sequences, communication is carried out using interactive conversational and/or generative AI (artificial intelligence), to resolve raised issues and settle irregularities by continuous machine learning. In application, disclosed systems and methods were able to increase the efficiency of human-based communication systems and the rate of conflict resolution by at least a third.

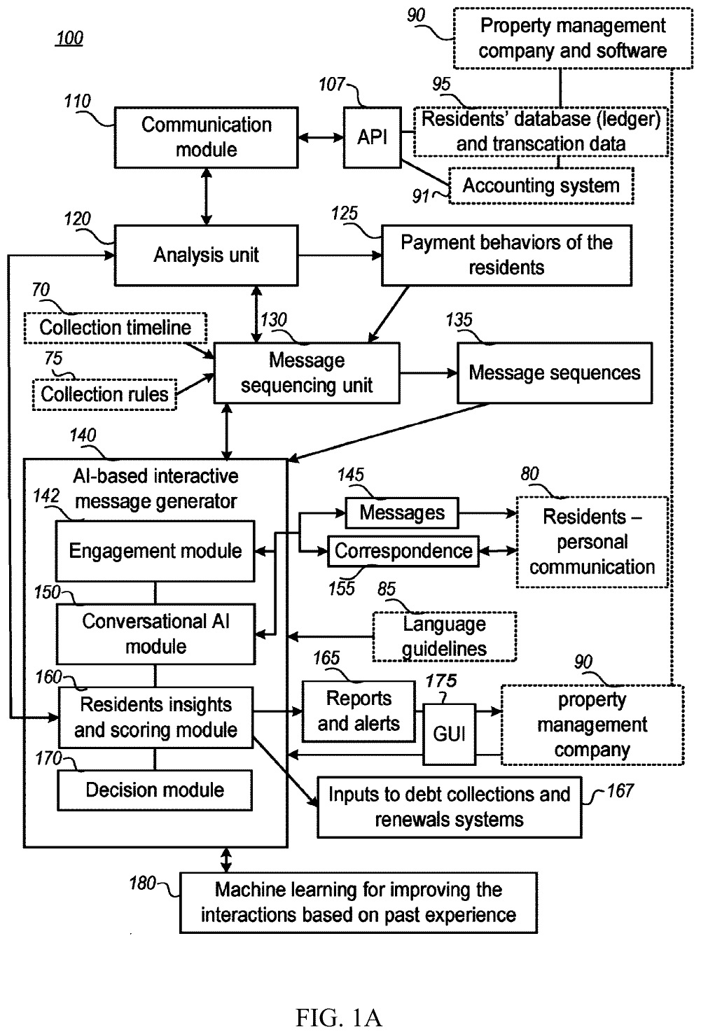

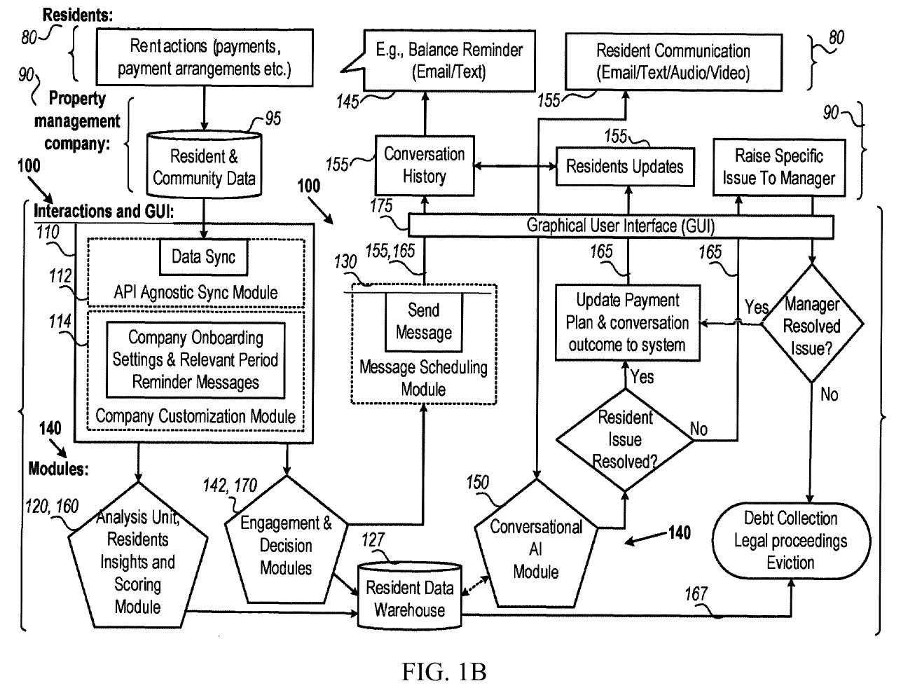

FIGS. 1A and 1B are high-level schematic block diagrams of system 100 for communicating with residents 80 with respect to rent collection, according to some embodiments of the invention. FIG. 1A provides a schematic block diagram of system modules and their interactions, while FIG. 1B provides a layered illustration of the interactions between system 100 and the property management company and the residents, as disclosed herein.

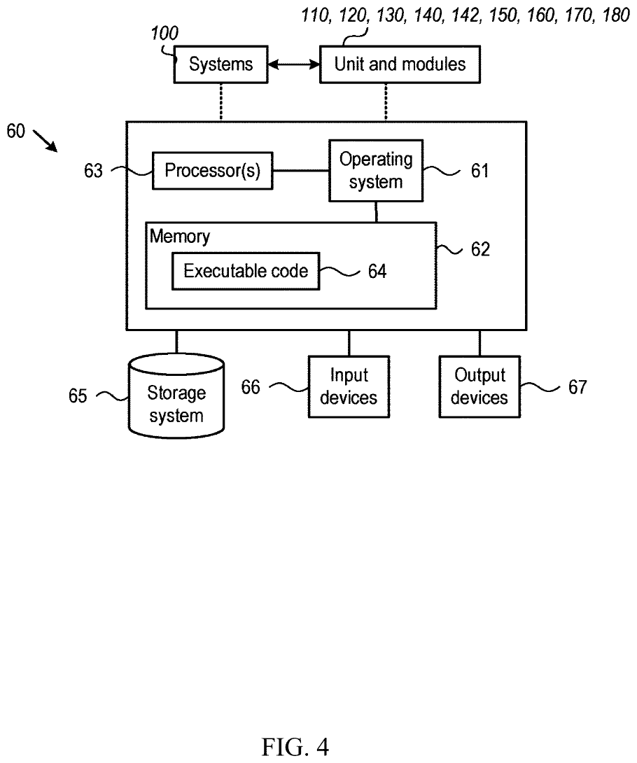

As illustrated schematically in FIG. 1A, system 100 may comprise a communication module 110 configured to communicate with an API (application programming interface) 107 of a property management company (and its software, PMS) 90 and to provide access to a database 95 (via the PMS, e.g., a ledger and transaction data, e.g., past payments, and various types of payments such as rent, late fee; pet fee; late charges, utility charges, lease data, contact details, status, etc.) thereof. Disclosed systems 100 may be coupled to API 107 by any type of communication link (wired or wireless, over any type of protocol or medium), and comprise storage device(s) 62 and processor(s) 63 coupled to storage device(s) 62 (see FIG. 4), which store software instructions for controlling processor(s) that, when executed, configures the processor to implement the following operations by the disclosed modules. Alternatively or complementarily, system 100 may be configured to receive data from property management company 90 via other means, such as daily reports (e.g., of payments), or from other types of data sources. In some embodiments, system 100 comprises API 107 itself, providing for the first time a dedicated API for propelty management purposes. It is noted that API 107 is constructed in various ways for the purpose of property management, specifically providing the tight schedule for the timeline of collecting rent, as explained herein, and relating the payments of the residents to the defined timeline. Communication module 110 is further configured to maintain the data available to system 100 and its units and modules up to date, and enable querying the database for specific details if needed. Communication module 110 may further be configured to communicate with an accounting unit 91, e.g., via API 107, keep payment data update, and enable payment queries from system 100 and its units and module.

System 100 may be configured to access database 95 (e.g., including a ledger comprising data related to residents 80 and various types of payments and time-related conditions as described herein, managed by property management company 90 and past payments records of the residents. Certain embodiments comprise computer program products that comprise a non-transitory computer readable storage medium having computer readable program embodied therewith, the computer readable program configured to carry out the various operations disclosed herein with respect to systems 100 and/or unit and modules of system 100.

It is noted that prior to the development of systems 100, no API was available for receiving transaction information from property management company 90. As part of systems 100, API 107 was developed to include all relevant payment information (available at property management company 90, but not used previously), including all types of resident's charges (e.g., rent, pet fee, late fees, etc.), all types of unit/apartment charges (e.g., water, electricity or other infrastructure fees when applicable), as well as the payments made by the resident, their exact time and amounts, which systems 100 use to provide information to the residents concerning their balance and explain the sources for the due payments (as part of correspondence 155).

As illustrated schematically in FIG. 1B, resident actions such as payments and payment arrangements may be accessed via database 95 including residents and community data, and shared with system 100 via API's to achieve data synchronization. For example, communication module 110 may comprise an API agnostic sync module 112 connected to a company customization module 114 which includes the specific company's onboarding setting and rent collection parameters such as a collection timeline 70 (e.g., dates for due payments, grace periods, late fees and legal proceedings such filing for an eviction) and specified collection rules 75 (e.g., exceptions to the specified collection timeline, exceptions relating to exact sums or timing of made payments, etc.). Coupling of system 100 with API 107 and reception of collection timeline 70, collection rules 75, payment plans, and other company-specific rules and information may be carried out via an onboarding interface (not shown) to define and optionally modify and/or over a company interface, as described below (see GUI 175).

Returning to FIG. 1A, disclosed systems 100 may further comprise an analysis unit 120 configured to analyze payment records associated with the managed residents (from database 95) and de live payment behaviors 125 of the residents.

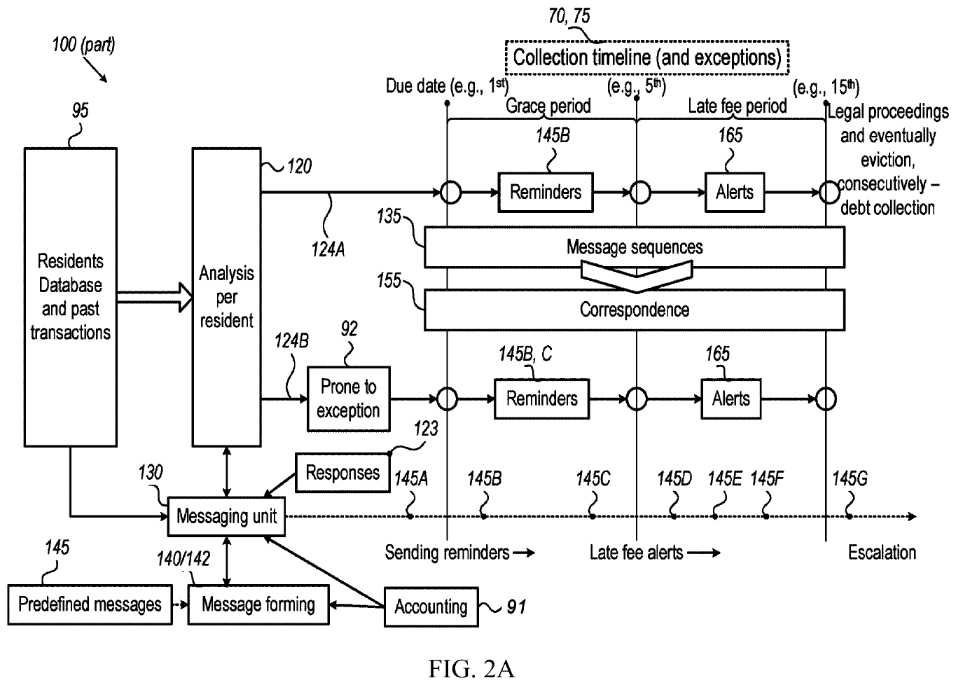

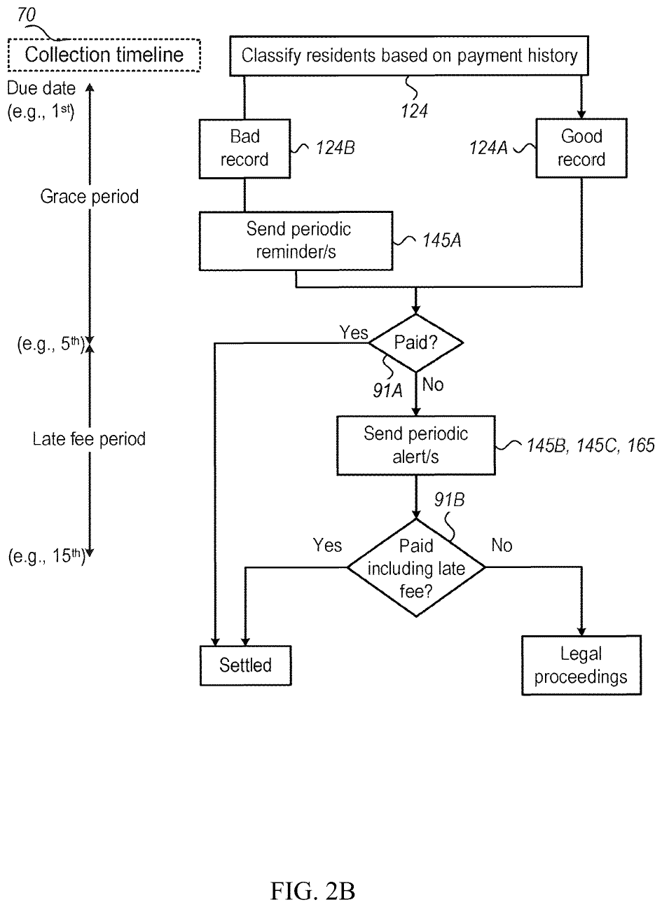

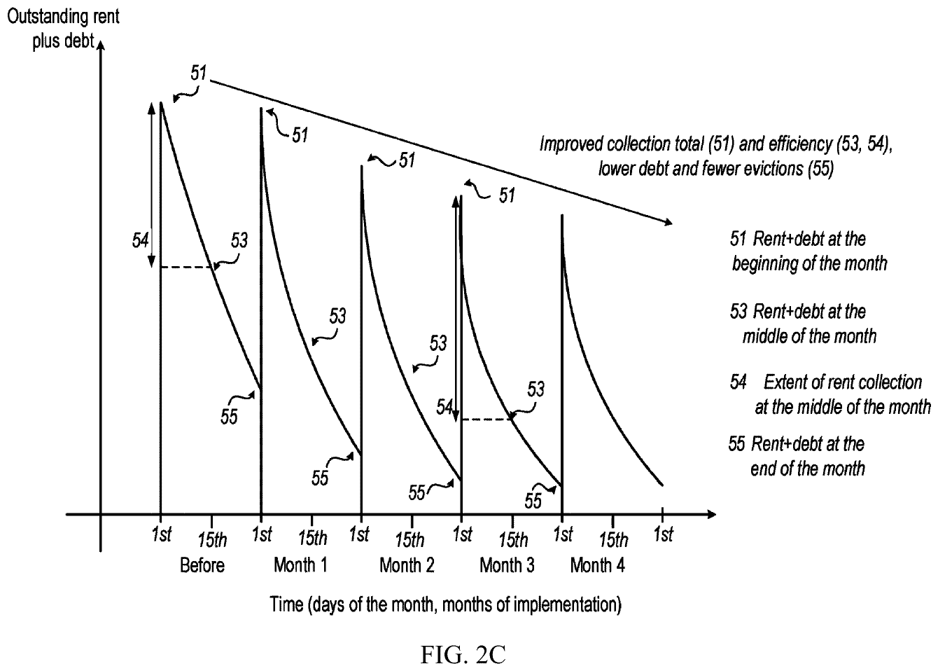

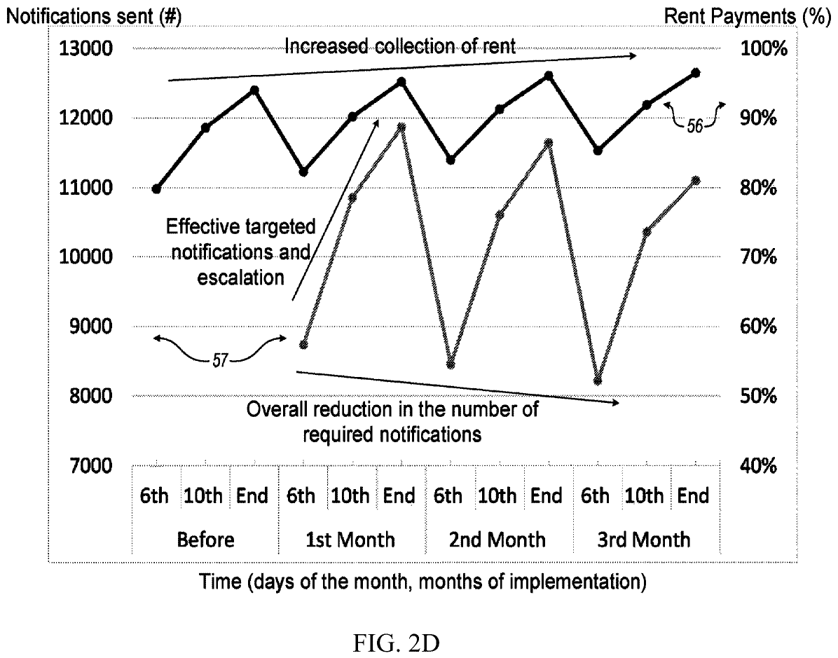

Disclosed systems 100 may further comprise a message sequencing unit 130 configured to-derive corresponding message sequences 135 related to derived payment behaviors 125, and with respect to specified collection timeline 70 and specified collection rules 75. Examples for details concerning the sequencing concept and timelines are provided below (see. e.g., FIGS. 2A and 2B).

Disclosed systems 100 may further comprise an AI-based interactive message generator 140 configured to-send messages 145 and to correspond with residents 80 to promote rent payments-according to derived message sequences 135 and with respect to responses received from residents 80 as part of correspondence 155 with residents 80. Derived message sequences 135 and interactive messaging 145 and correspondence 155 are specific to individual residents 80, and systems 100 are configured to communicate with at least hundreds or thousands of residents 80 simultaneously. Conversational or generative AI 150 may be used to handle correspondences 155, e.g., under limitations of proper language 85. The interaction with residents 80 is gradually modified (e.g., escalated) with respect to content and tone of the messages in correspondence 155 with respect to analyzed payment records 125 and with respect to the received responses.

In various embodiments, systems 100 and/or analysis unit 120 may be further configured to analyze the resident collection behavior with respect to different database parameters (e.g., socio-economical parameters, geographic region, employment status and data, possibly socio-economical parameters, etc.), and adjust the interaction accordingly. Interaction may be gradually improved by application of ML and continuous refinement and adjustment of the interaction model. Analysis may be carried out based on payment behaviors 125 and/or based on the continuous correspondence 155 with the residents. As illustrated schematically in FIG. 1B, payment behaviors 125 as well as all collected data concerning the residents may be stored in a resident data warehouse 127, which provides basis for machine learning and continuous improvement of system 100 and its components, specifically the various AI modules such as described herein and below.

In certain embodiments, analysis unit 120 and/or AI-based interactive message generator 140 may be further configured to identify expected date of payment, and adjust correspondence 155 accordingly (e.g., reminding the residents of the additional payment prior to that date, or following up afterwards); and/or suggest a payment plan that may fit the abilities of the resident (in accordance with property management company's rules)—and follow up on the payment plan in correspondence 155 with resident 80. This information may also be presented to property management company 90 (e.g., via a graphical user interface—GUI 175) as expected collection data, which is reasonably based on correspondence 155 with the residents and their past payment performance.

It is noted that management of payment plans and installments is particularly difficult in the prior art, as it requires additional attention to the correspondence and collection process. Disclosed systems 100 however—allow personal suggestions and follow ups for any suggested plan. Moreover, systems 100 also allow following up with the residents with respect to determined EPD's (expected payment dates), which are also very problematic in the prior art. Moreover, systems 100 provide payment predictions to property management company 90—which take into account such payment plans and EPDs. For example, interactive message generator 140 may be further configured to suggest and follow up the execution of payment plans for specific residents, and provide corresponding expected payment data.

In various embodiments, AI-based interactive message generator 140 may be configured to operate as an extension of property management company 90 and be configured to have good conversation skills, good understanding of the current residents (behaviors, payment history, and even character) and also exhibit good judgment and decision making. Accordingly, in a non-limiting example, interactive message generator 140 may comprise correspondingly an engagement module 142, conversational AI module 150, a residents' insights and scoring module 160 and a decision module 170. In various embodiments, messaging unit 130 may be part of engagement module 142 and/or conversational AI module 150, messaging unit 130 may be configured to include engagement module 142 and/or conversational AI module 150 or parts thereof, or some or all of the computational structure (e.g., algorithms, networks and/or parameters) may be at least partly common to messaging unit 130 and engagement module 142 and/or conversational AI module 150. In various embodiments, residents' insights and scoring module 160 may be part of analysis unit 120, analysis unit 120 may be configured to include residents' insights and scoring module 160, or some or all of the computational structure (e.g., algorithms, networks and/or parameters) may be at least partly common to analysis unit 120 and residents' insights and scoring module 160.

In various embodiments, systems 100 provide to residents 80 any required explanatory information, such as explanations and details concerning the required sums—thereby promoting payment. Systems 100 may also adjust the method of communication with each resident according to their preferred channel of communication (messages, call, emails, voice, video, etc.), which also promotes payment by adjusting to the convenient channel of communication for each resident. The method of communication with each resident may be adjusted seamlessly between channels and continue conversations that began in one channel in another channel. In various embodiments, AI-based interactive message generator 140 may be configured to adjust delays in response to the typical delays in the preferred channel of communication (e.g., about a minute for a message, and about ten minutes for an email, depending on system definitions). Interactive message generator 140 may be further configured to detect and/or adjust the communication language (e.g., based on prior information and/or based to detection of the language used in the communication), or switch languages, with respect to data related to the residents and/or their communication preferences.

Engagement module 142 may comprise an AI module trained for deciding how and when to approach each resident 80 and provide the core for generating outgoing communication 155 with residents 80—deciding when are the best day and time to approach each resident and which message should be sent out. Engagement module 142 may be configured to tailor the experience and create the most personalized communication possible, to create the most impact and attract the most attention and lead to action, as evident in the results presented below that indicate the improvement provided by engagement module 142 over manual (human) communication. Engagement module 142 may be further trained to optimize both the resident engagement and the collection process, based on all available input data such as parsed resident data from database 95, residents ledger and transaction data, onboarding variables, and data from correspondence 155 of the resident with system 100, including all prior communications. For example, engagement module 142 may derive and utilize daily, personal analysis based on resident's scoring, dates and historic data to assess whether to send rent payment reminders and to derive their content. Moreover, systems 100 may be configured to derive from past correspondence with individual residents the credibility of each resident, sentiments expressed by the residents, attempts to deceive, etc., and take these into account in determining correspondence 155, e.g., the degree to which urgency is expressed, tone is escalated, frequency of messaging, timing of alerts, etc. In various embodiments, systems 100 may be configured to escalate the collection process to one or more property managers, depending on various preferences and definitions. For example, interactive message generator 140 may be configured to escalate the tone and increase a frequency of the messages upon non-payment and/or according to the specified collection rules. In various embodiments, systems 100 may be configured to adjust various parameters instructions and definitions by the property management companies, e.g., with respect to specific properties and their level of occupancy. Non-limited examples are provided below, with respect to FIGS. 2A and 2B.

Conversational and/or generative AI 150 may be used to generate and evaluate correspondence 155. In a non-limiting example, conversational AI module 150 may generate and manage conversation with residents 80 throughout the different channels, including text, voice and possible video, assisted by generative models—hence managing correspondence 155 in a broad sense. Conversation and/or generative AI 150 may be configured to include negotiating payments and delays, addressing residents' general concerns and questions. Moreover, conversational and/or generative AI 150 may be configured to predict and/or understand if and when late payers are going to pay their balance, and adjust correspondence 155 accordingly.

Conversational AI module 150 may be configured to derive the most appropriate response for each communication from each resident 80, based on the resident's analysis by analysis unit 120 and on the resident's other historic data, as well as based on the context of the conversation, and with respect the general scheme of message sequences 135, collection timeline 70 and collection rules 75. In various embodiments, conversational AI module 150 may comprise several interconnected layers, each handling the more specific tasks of (i) understanding the resident's message, (ii) extracting entities from the message (e.g., names and dates), (iii) choosing the best reply from a given closed or open list, according to all data and context, (iv) adjusting the reply according to proper language rules 85, etc. Conversational AI module 150 may be further configured to provide explanatory comments concerning a payment balance of the specific resident, e.g., relate the balance to various types of fees (e.g., debt, missing installments, various payments, e.g., for water, pets, etc.) and provide explanations concerning various components of the balance in a natural language adjusted to the specific resident.

It is noted that conversational AI module 150 may comprise both determined rules and AI sub-modules, which may be restricted by various language guidelines, e.g., relating to proper language use, resident data, and customization related to specific residents, specific properties, specific property owners and/or specific property management companies 90, such as specific conditions or requests concerning them.

In various embodiments, conversational AI module 150 may be configured to adjust messages 145 and/or correspondence 155 to specific types of residents, such as participants in a housing choice voucher program (Section8/HUD), rental assistance communities, students, etc., adjust the collection communication to receipt of payment by an assisting organization (e.g., municipality, government or other organizations), multiple payers per unit (e.g., several students), and/or to adjust messages 145 and/or correspondence 155 to specific types of properties, such as private or commercial properties (e.g., communication with a commercial entity is different from a private one), multi-family or single family properties, etc.

In certain embodiments, engagement module 142 may be configured to handle initial messages 145 according to message sequences 135, while conversational AI module 150 may be configured to handle further correspondence 155. In various embodiments, engagement module 142 may be part of conversational AI module 150, conversational AI module 150 may be configured to include engagement module 142, or some or all of the computational structure (e.g., algorithms, networks and/or parameters) may be at least partly common to engagement module 142 and conversational AI module 150.

The AI sub-modules may implement various AI technologies, such as various deep neural network architectures, transformer technologies, etc. Conversational AI module 150 may also comprise rules for handling uncertainties concerning the optimal reply, for example, include rephrasing messages, clarification questions, involving a human interpreter in specific cases, or consulting a representative of property management company 90. It is noted that the nature of correspondence 155 does not require real-time interaction and allows delays, e.g., of a few minutes, allowing involvement of human interpreters where needed. In such cases conversational AI module 150 may be configured to maintain resident privacy by removing personal details and preventing the human interpreter from accessing them, rephrasing the unclear issue to receive the required instruction. Moreover, automated system 100 may relieve privacy concerns for residents, as all data and handling may be secured and protected from external entities. Conversational AI module 150 may be further configured to learn from the resolutions of such uncertainties to improve future correspondence 155 in similar cases, e.g., using additional automatic or human training, labeling and machine learning. As shown below, the reduction of correspondence volume over time indicates the improvement achieved by systems 100 over and beyond human performance or initial machine performance.

Residents' insights and scoring module 160 may be configured to derive and provide further analytics related to correspondence 155 with residents 80, beyond the initial analysis by analysis unit 120. For example, residents' insights and scoring module 160 may be configured to build and internal resident scoring using machine learning and based on historic accounting history from property management company 90. The information from correspondence 155 may be related to previously derived payment behaviors of the residents 125 (e.g., lease information, parsed ledger data, payment history etc.) and enhanced by a resident scoring model derived as an AI-based prediction module trained to assess the ability and willingness of a resident (or of a past resident) to pay their debt. This resident scoring model is constantly trained on historic data as well as on the updating payments and behavior during correspondence 155, and data is shared with other modules in system 100. For example, accumulating data used for the training may include the number of interactions with system 100, the degree of required escalation during the interaction, times when the resident most responsive (e.g., for use by engagement module 142), information extracted from the correspondence 155 such as reasons for being late, salary details for each resident (timeline and sums), job details (types and periods of past jobs), personal issues, etc.

Decision module 170 may be configured to determine for each resident specific decisions or actions supported by system 100, such as the possibility of delaying or spreading payments within specific boundaries, settlements on reduced payments within specific boundaries, other negotiable aspects, indications of required escalation (e.g., nonresponsiveness), etc. For each of these issues, which may be handled in real-time or with delay, specific rules may be derived and adjusted with respect to the specific resident and the specific issue, checked with representatives of property management company 90 when needed, and used for further training decision module 170 to improve handling future cases. The improvements are shown below in examples for increased rent collection rates, reduced extent of messaging required, and reduced eviction rates (indicating more successful negotiations and less hassle for the residents and to the management company).

In various embodiments, systems 100 and/or AI-based interactive message generator 140 may be configured to generate reports 165 concerning ongoing rent collection and alerts 165 concerning non-payments (e.g., with respect to pre-defined limits on the system's compliance with resident requests), provide these to property management company 90 via a GUI 175 and receive further instructions and decisions concerning specific residents and collection situations. For example, GUI 175 may be configured generate and display cyclic collection reports that provide data indicating a rent collection speed and remaining debt in the following month, as well as alerts concerning nonpayments, e.g., as illustrated in the schematic example in FIG. 2C.

As illustrated schematically in FIG. 1B, in cases resident and/or payment issues arise, conversation AI module 150 may be configured to raise specific issues to the managers to try to resolve possible difficulties or conflicts. Moreover, information from the related correspondence and considerations may be used in future handling of debt collections (167). Accordingly, even for residents leaving the property, data from systems 100 may be used to support further communications with the leaving resident to make debt collection more efficient.

Finally, machine learning 180 may be implemented to improve the interactions of systems 100 with the residents based on past experience with the same residents or with other residents that share common features, individually (e.g., with respect to payment and/or communication parameters) or collectively (e.g., with respect to group or socioeconomical parameters).

Returning to FIG. 1A, both residents' insights and scoring module 160 and decision module 170 may be configured to correspond with representatives of property management company 90 via GUI 175, either in real-time or with some acceptable delays, and further train their respective AI modules to improve future interactions with residents (e.g., relating to future actions such as debt collection and rent renewals) based on inputs from the representatives.

In various embodiments, systems 100 interact simultaneously with at least hundreds or thousands of residents, and may reduce the total number of messages sent to residents and/or escalated to the property manager by at least 5% and/or to increase collection of unpaid rent collected by at least 30%—with respect to rent collection carried out manually.

### Examples

In multiple implementations of system 100, it was found to provide convincing, consistent, back-and-forth correspondence 155 with residents 80, with them usually considering correspondence 155 to be conversations with real people, encouraging quicker turnaround times for payments. System 100 was found to increase the productivity levels by answering easy questions for residents, including payment-related questions (balance due and suggesting payment plans), thus encouraging quicker payment, and thereby freeing up additional time for company employees to focus on new leasing and renewals, and keeping the apartment communities operating at peak efficiency.

In one case, system 100 was implemented for a three-months' pilot program handing rent payments from over 2500 units across 22 locations, managed by one property management company. During this three-months' period, implementation of system 100 resulted in a 23% decrease in uncollected rent, achieved gradually from month to month as communication with the residents improved (rising from 16.5% improvement in the first month), while exchanging ca. 6500 messages with the residents. Systems 100 thus proved both capable of handling extensive communications beyond reasonable human capacity and effective in improving the collection results beyond previous human managements. It is noted that improved collection results are not merely financial, but also correlate with fewer resident evictions and increased efficiency of the property management.

In data accumulated over a year, relating to 154 properties including over 32,000 unit and handled by 29 property management companies, an average improvement of 44% has been achieved in rent collection-further indicating the efficiency and benefits of systems 100 over manual management, improving collection rates, reducing eviction rates, and improving the efficiency of property management as a whole.

In another example, implementation of systems 100 yielded a reduction in the number of non-payers from 5% to 3.5%, by timely communication with the residents and resolving their issues, improving rent collection by about a third (reducing unpaid rent by 30%).

The improvements provided by systems 100 are expressed in various parameters, such as increases in debt collection (sum of rent collected at the end of month), quicker rent collection (earlier collection), reduction in problematic cases that require human intervention, better characterization of the residents that improves the overall management of the properties, enhanced fairness and greater possibilities for effective negotiation and compromises in the interaction with the residents, which builds trust on both sides and settle issues earlier, and reduction in the extent of required legal proceeding, debt collection, and eviction—which is beneficial to the residents, the property management companies, and the system as a whole. Moreover, integrated AI and machine learning processes continue to improve systems 100 as explained herein, leading to ever growing benefits and improvement of systems 100 themselves.

FIGS. 2A and 2B are high-level schematic illustrations of non-limiting examples for communication flows with residents, according to some embodiments of the invention. These examples are schematic and simplified, and do not limit the scope of the invention, and in particular the complexity that may be achieved by the various AI modules (e.g., of interactive message generator 140 described in FIGS. 1A and 1B) and their ability to learn the payment behavior of each resident and adjust correspondence 155 with each specific resident 80 accordingly.

Residents database 95 may maintain a list containing personal data on each resident (or tenant), such as the resident's communications details, workplace, previous paychecks and possibly employment history, history of rental payments (transaction data), including the history of timely meeting the payment-directive requirements, credit score, past evictions, communication history, optionally a total score for meeting the company by each resident. etc. Residents' database 95 may be updated from time to time, for example, monthly, by property management company 90, and data warehouse 127 receiving initial data from residents' database 95 may add various data to it, as disclosed herein.

In a non-limiting example, just before the beginning of each month, analyzing unit 120 may analyze and classify each individual resident, e.g., as individuals that usually pay the rent on time (option 124A), and as individuals that generally fail to timely pay the rent (option 124B, possibly prone to exceptions 92 defined by property management company 90). It is noted that residents 80 may be classified into a larger number of groups or handled individually using classification based on machine learning, that is updated continuously during the operation of system 100, and that FIG. 2A merely provides a highly simplified example. Given the two groups 124A, 124B, messaging unit 130 may start sending one or more rent payment reminders—initially according to defined message sequences 135 and progressively adjusted to specific resident replies and correspondence 155—denoted schematically by numerals 145A through 145G as explained herein. In the non-limiting example, collection timeline 70 may start on each month's 1st day, include 5 days of grace period and additional ten days of late fee period, before legal proceeding, debt collection and eviction notices and proceedings follow. Further distinctions may be made between residents that leave the property without paying their debt, and residents that stay in the property without paying their debt, and correspondence 155 may be adjusted accordingly, depending on the size of debt, state of the property, resident financial and past correspondence data, socio-economical parameters, business considerations of property management company 90 (any of which may be at least partly incorporated into systems 100). As these considerations also depend on the type of managed properties and types of residents, required adjustments of all parameters may be implemented in advance and/or following machine learning 180 with respect to specific types properties and residents.

In some cases, collection rules 75 may define exceptions that simplify settling these issues, such as allowing for partial and/or late payment, depending on the circumstances. Clearly the collection timeline may be defined specifically with respect to the management companies, specific residents (e.g., providing advance payments or multiple payments) and further adjusted with respect to collections rules 75 (e.g., avoidance of messages on holidays, providing reminders on expected paydays, different timing depending on resident responses or past behavior, and so forth).

For example, if AI-based interactive message generator 140 receives a notice from a resident informing that they'll get paid on the 5th as part of correspondence 155, further correspondence may include reminders to pay on the 5th or on 6th, making sure the resident utilizes the money to paying the rent first. In another example, if AI-based interactive message generator 140 receives a notice from a resident requesting for payment installments because of a money issue as part of correspondence 155, further correspondence by AI-based interactive message generator 140 may include approval of the request based on the scores and other details relating to the specific resident, and then follow up in further correspondence according to the agreed installment dates, to verify payment. Within predefined borders, this correspondence and follow ups do not require any manual involvement from property management company 90, and may be handled automatically and represented in the expected collection data.

Residents of different groups may receive different sequences of messages, and escalation may be carried out according to different rules, with respect to the learned interaction model (e.g., residents in group 124A may receive fewer messages 145B, which may possibly be triggered later, with respect to residents in group 124B who may receive more messages 145B, 145C, more late fee reminders 145D, 145E, 145F, 145C, which may possibly be triggered earlier 145A, e.g., for specific residents). Additionally, escalation messages 145G may be used to possibly resolve missing rent payments in specific situations, possibly involving managers (see FIG. 1B)—to avoid further escalation and possibly eviction of specific residents 80 that may be able to overcome temporary lack of resources. Advantageously, disclosed systems 100 may learn to identify such cases from the accumulating residents' information and behavior—and reduce the number of resulting evictions to the benefit of both residents 80 and property management company 90.

A message forming module (or engagement module 142) may be part of interactive message generator 140, utilizing predefined messages 145 (e.g., relating to initial message sequences 135) and adapting the messages based on individual resident data 95 (e.g., personal details, history of payments, etc.). The number of messages sent to each resident during the grace and late fee periods may also vary depending on the individual details, and when more than one message is sent, the urgency (and tone) of the message may increase from one message to the next (e.g., 145A through 145F). As indicated schematically, the interaction with each resident 80 is based on specific message sequence 135 (predefined, derived from general rules and with respect to timeline 70, and/or derived specifically per resident 80) and evolves interactively into correspondence 155, derived by conversation/generative AI 150 on the basis of the resident's payment behavior and responses to the initiatory message sequence 135.

Accounting unit 91 associated with property management company 90 and/or managed directly by system 100 (e.g., managed by a PMS) may continuously (or periodically at a high rate) be updated on any payment made by residents 80, the exact payment dates and sums, and corresponding data may be used for the interactive messaging (e.g., to settle rent payment, note partial payment and request additional payment, follow up on required installments, etc.). At any given time, and following the required resident's payment, messaging unit 130 stops sending reminders (or alerts) to that resident. If payment is not received during the late fee period, messaging unit 130 may be configured to send more urgent messages or escalate the tome of the messages (e.g., 145D, 145E, 145F) to the relevant residents and/or alerts 165 to property management company 90, e.g., indicating that a surcharge (late fee) is applied and that an eviction claim may be filed if payment is not received by the deadline (e.g., the 15th). Several alerts may be sent during the late fee period if payment is not received at accounting unit 91. The level of urgency (and possibly also the aggressiveness and frequency of sending, e.g., according to language guidelines 85, while maintaining proper language) may increase from one message to the next, emphasizing the approaching state of pending eviction. The sending of messages may terminate once accounting unit 91 informs messaging unit 130 that the respective payment has been fully received. If no payment is received by the late fee deadline, the property manager may revert to filing an eviction, and an informing message 145G may be sent by messaging unit 130. The number of messages sent and the periods between one message and the next may be set (automatically or based on predefined rules) according to the resident's payment history, management definitions, and other circumstances. The type of individual messages may be selected from one or more SMS, WhatsApp, email, or possibly involve voice or video interaction, automated or manual (in exceptional cases).

Conversational AI module 150 of interactive message generator 140 may also be adapted to analyze any resident's response message(s) 123 to create response message(s) to the residents as part of correspondence 155. For example, if the resident responds by “I plan to pay X USD tomorrow”, the message forming unit, in response, may analyze the resident's message and may automatically respond by drafting and sending another message, saying, “thanks, this will close all your rent up to the end of this month,” or “please note that you have to pay an additional surcharge (late fee) of Y USD, due to your late payment last month.” The drafting of the message may be performed based on machine learning, predefined rules, or a combination thereof, in association with data obtained for that resident from accounting unit 91. The message forming unit and/or engagement module 142 of interactive message generator 140 may be configured to use collection data and correspondence from previous month(s) to adapt the next month sequence according to messages sent by the respective residents, for example if a resident notes they will pay the next rent on the 8th, the first message on the following month may relate to this information but adjusting the reminder date in the message. In another example, if a resident paid late or had another exception in one month, the message for the next month may be adjusted to check of the late payment or exception are also expected for the following month.

FIG. 2B illustrates schematically another non-limiting example of gradual escalation and correspondence 155 with residents 80. The process may include initial resident classification 124 to two or more groups, e.g., “bad record residents” 124B or “good record residents” 124A, or individual characterization of each resident using more detailed criteria). During the grace period from 1st to 5th of the month, reminder messages 145A may be sent only to residents classified as having a bad payment record 124A. It is noted that this is a different example from FIG. 2A, in which bad record residents are reminded 145A even before the due date, and all residents are reminded after the due date). Consecutively, at the beginning of the late fee period (6th day of the month), the monthly payments made up to this point may be checked with accounting unit 91, and correspondence 155 may be terminated for residents who settled their payments. However, for each resident who failed 91A to pay appropriately, additional messages 145B, 145C may be sent, as well as alerts 165 to property management company 90—indicating that payment with surcharge (late fee) should be made up to the 15th day of the month and optionally one or more of those messages may include escalating tone or content, as well as options for alternative settling of the payment. Once payment with surcharge is done 91B (according to accounting 91), correspondence 155 may be terminated for residents who settled their payments, but escalation to legal proceedings may be applied to residents who failed to appropriately pay their payment by the end of the late fee period. It is noted that collection rules 75 may comprise modifications to payment conditions, e.g., accept payment even if they are short by a small sum, allowing for minor delays, etc., representing reasonable flexibility, e.g., as defined by property management company 90.

As noted, messaging unit 130 may send messages formed by message forming unit or engagement module 142 in an interactive manner, based, e.g., on predefined rules, individual user's data, and accounting data, machine learning that considers individual resident's data and accounting data, possibly involving a training stage in which many real previously sent messages and respective circumstances are fed to form a learning unit that tailors a message for each individual at any given time. Moreover, interactive message generator 140 is configured to continuously update the way correspondence is generated to improve collection.

For example, engagement module 142 may be configured to use many different factors to select which residents to approach in what way, seeking to minimize the scope of messaging and not bothering residents that pay their rent regularly (e.g., group 124A). Moreover, engagement module 142 may be configured to use the parameters and machine learning to change the timing of messages and adjust their content and tone-to maximize rent collection while minimizing messages scope, intervention requirement and resident eviction.

FIGS. 2C and 2D provide schematic non-limiting examples for improvements in efficiency of rent collection and in communication with the residents through disclosed systems and methods, according to some embodiments of the invention.

FIG. 2C is a highly schematic example, based qualitatively on collection results from tens of property management companies 90, hundreds of properties and thousands of residents 80. Through the implementation of disclosed systems and methods, the total outstanding rent and debt at the beginning of the month (denoted 51) gradually decrease, as do the outstanding rent and debt at the middle of the month (denoted 53, with arrows 54 further indicating the greater extent and improved speed of collection related to the increasing slopes during the first two weeks) and the outstanding rent and debt at the end of the month (denoted 55). All these indications show an improvement in collection, as well as related reduction of debt and associated legal proceedings and eventually evictions. Moreover, the number of required messages and correspondence decreases gradually as disclosed systems and methods improve via machine learning. In fact, within a few months, disclosed systems and methods were also shown to gain significant insights concerning the residents, which enabled more efficient management of the properties and smoother rent collection-further enhancing cooperation and trust between residents 80 and property management companies 90.

FIG. 2D provides a concrete example, based on systems 100 handling rent collection from residents in 10,008 units over three months, illustrating the achieved increase in rent collection (denoted 56, from 94% at the end of the month before implementing system 100 to 96.5% at the end of the third month) and the improved efficiency in rent collection-showing even larger increases at earlier days of the month (by the 6th day of the month-from 79.8% before to 85.3% after three months, equivalent to about 10% higher rent collection by the 6th, and by the 10th day of the month from 88.6% before to 91. 9% after three months, corresponding to the narrowing of the extent of debt by the middle of the month denoted 54 in FIG. 2C).

Moreover, FIG. 2D illustrates the increasing efficiency of the communication system itself, both in providing timely and accurate correspondence to the delaying residents, denoted as “Effective targeted notifications and escalation”—leading to the increased collection rates, and in the reduction of the overall number of required notifications over time, denoted 57—about 3% per month, resulting in a reduction by 9% of the number of required notifications over three months. It is further noted that manual handling of the great number of notifications—more than 11,000 per month, clearly indicates the great reduction of communication load off the human managers in property management company 90—clearly indicating the high efficiency of using recited AI-based systems 100.

Finally, additional data for the example illustrated in FIG. 2D relates to the number of issues escalated by system 100 to the office of property management company 90 for human decision, decreasing from 217 in the first month, to 203 in the second month and down to 181 issues in the third month—also illustrating the improvement of AI-based system 100 over time (average improvement of 6% per month, totaling 17% over the first three months).

It is noted that in many of the implementations, AI-based systems 100 optimize the rent collection within three to four months, and maintain the high level of efficiency over the following months.

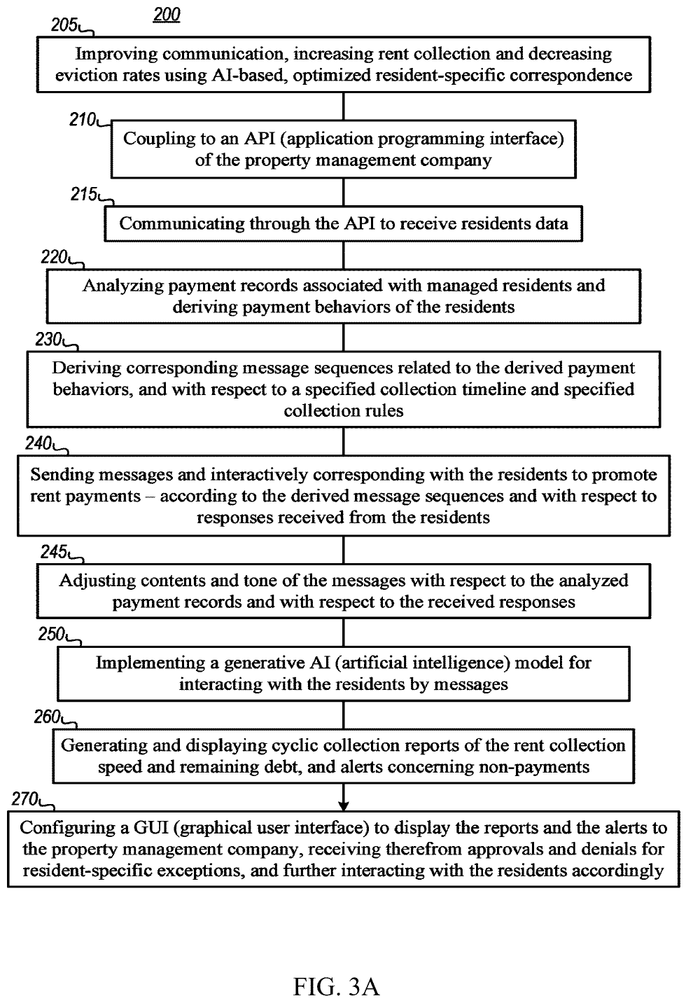

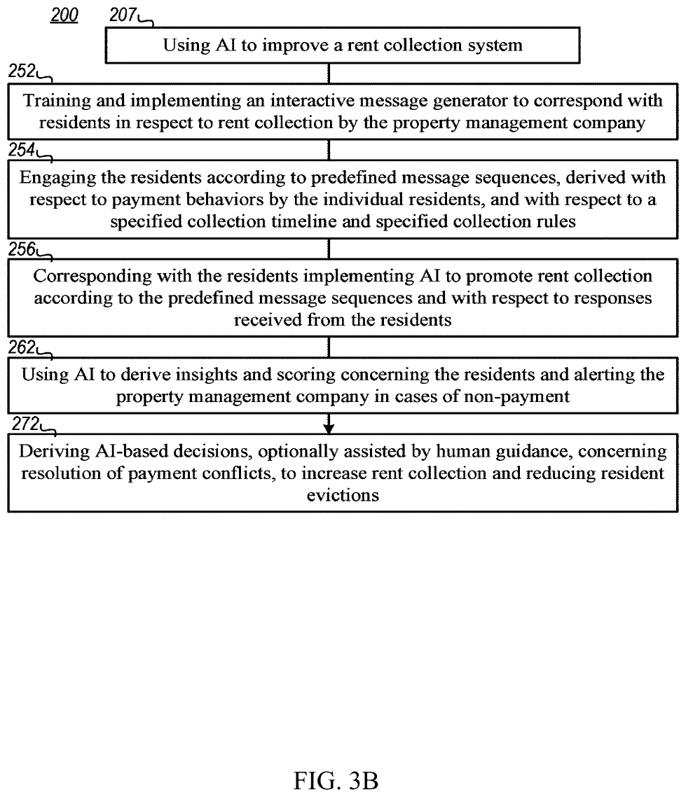

FIGS. 3A and 3B are high-level flowcharts illustrating methods 200, according to some embodiments of the invention. The method stages may be carried out with respect to system 100 described above, which may optionally be configured to implement methods 200. Methods 200 may be at least partially implemented by at least one computer processor, e.g., in any of the units or modules disclosed in FIGS. 1A and 1B, or controllers 60 (see below). Certain embodiments comprise computer program products comprising a computer readable storage medium having computer readable program embodied therewith and configured to carry out any of the relevant stages of methods 200. Methods 200 may comprise methods 200 of improving communication, increasing rent collection and/or decreasing eviction rates of residents managed by a property management company and optimizing resident-specific correspondence (stage 205) as well as methods of using AI (artificial intelligence) to improve a rent collection system (stage 207). Any of methods 200 may comprise the following stages, irrespective of their order.

Methods 200 may optionally comprise coupling to an API (application programming interface) of the property management company (stage 210) and communicating with the API (stage 215) to access a ledger database comprising residents managed by the property management company and past payments records of the residents. Alternatively or complementarily, methods 200 may receive data concerning the residents and their payments and payment plans in any other ways, e.g., in periodic spreadsheets.

Method 200 further comprises analyzing payment records associated with managed residents and deriving payment behaviors of the residents (stage 220), deriving corresponding message sequences related to the derived payment behaviors, and with respect to a specified collection timeline (e.g., including dates for due payments, grace periods, late fees and legal proceedings such filing for an eviction) and specified collection rules and/or exceptions (stage 230), and sending messages and interactively corresponding with the residents to promote rent payments—according to the derived message sequences and with respect to responses received from the residents (stage 240).

In methods 200, the derived message sequences and the interactive messaging are specific to individual residents, methods 200 are carried out to communicate with at least hundreds or thousands of residents simultaneously, and methods 200 increase rent collection and decrease eviction rates by tailoring the correspondence to the deriving payment behaviors of the residents and to the responses received from the residents, continuously improved by implementing machine learning and AI learning methods, as further disclosed, e.g., in FIG. 3B.

For example, deriving the predefined message sequences 230 may be carried out by continuous machine learning of the payment behaviors by the residents, based on ledger data and on collected correspondence of the residents with the interactive message generator. In another example, the correspondence with the residents may be adjusted using continuous machine learning with respect to contents, tone and degree of required escalation with respect to the specified collection timeline and specified collection rules.

Interactively corresponding with the residents 240 may further comprise suggesting and following up the execution of payment plans for specific residents, and providing corresponding expected payment data. Interactively corresponding with the residents 240 may further comprise providing explanatory comments concerning a payment balance of the specific resident.

Methods 200 may further comprise adjusting contents and tone of the messages with respect to the analyzed payment records and with respect to the received responses (stage 245). Adjustment 245 may further comprise escalating the tone and increasing a frequency of the messages upon non-payment and/or according to the specified collection rules.

Methods 200 may further comprise using a generative AI model for interacting with the residents by messages, wherein the generative AI model (and the generated correspondence) may be restricted by specified proper language rules (stage 250). For example, methods 200 may comprise training and implementing an interactive message generator to correspond with residents in respect to rent collection by a property management company (stage 252), engaging the residents according to predefined message sequences, derived with respect to payment behaviors by the individual residents, and with respect to a specified collection timeline and specified collection rules (stage 254), and corresponding with the residents implementing AI to promote rent collection according to the predefined message sequences and with respect to responses received from the residents (stage 256). The AI models may be continuously improved by machine learning to better adjust the correspondence to individual residents and past correspondence with them as well as to adjust the correspondence to groups of residents with similarities concerning their modes and types of interactions and payment behaviors. The continuous improvement may further reduce the required amount of communication, increase trust and rent collection and reduce eviction rates.

Methods 200 may further comprise generating and displaying cyclic collection reports that provide data indicating a rent collection speed and remaining debt in the following month, as well as alerts concerning non-payments (stage 260). For example, methods 200 may comprise using AI to derive insights and scoring concerning the residents and alerting the property management company in cases of non-payment (stage 262). In certain embodiments, methods 200 may further comprise configuring a GUI (stage 270) to display the reports and the alerts to the property management company, receiving therefrom approvals and denials for resident-specific exceptions, and further interacting with the residents accordingly. Moreover, in certain embodiments, methods 200 may further comprise deriving AI-based decisions, optionally assisted by human guidance, concerning resolution of payment conflicts, to increase rent collection and reducing resident evictions (stage 272). For example, using and learning from decisions and instructions received via the GUI, the AI based decision module may implement corresponding decisions in other cases and thus make the collection process as well as the system operation more efficient.

In certain embodiments, methods 200 may be configured to reduce the total number of messages sent to residents and/or escalated to the property manager by at least 5% and/or to increase collection of unpaid rent collected by at least 30%—with respect to rent collection carried out manually, as well as to reduce the number of required eviction—by achieving earlier and more acceptable payments and/or settlements than achievable by limited human managing capacities—due to the tailoring of the correspondence to the deriving payment behaviors of the residents and to the responses received from the residents.

FIG. 4 is a high-level block diagram of exemplary controllers 60, which may be used with embodiments of the present invention. Any of systems 100, units or modules thereof (110, 120, 130, 140, 142, 150, 160, 170, 180) as well as any of stages of methods 200 may be implemented using controllers 60 or parts thereof such as processor(s). Controller(s) 60 may include one or more controller or processor 63 that may be or include, for example, one or more central processing unit processor(s) (CPU), one or more Graphics Processing Unit(s) (GPU or general-purpose GPU-GPGPU), a field-programmable gate array (FPGA), an application-specific integrated circuit (ASIC), a digital signal processor (DSP), a microprocessor, a chip, a microchip, an integrated circuit (IC), or any other suitable multi-purpose or specific processor, controller or computational device, an operating system 61, a memory 62, a storage 65, input devices 66 and output devices 67.

Operating system 61 may be or may include any code segment designed and/or configured to perform tasks involving coordination, scheduling, arbitration, supervising, controlling, or otherwise managing operation of controller(s) 60, for example, scheduling execution of programs. Memory 62 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short-term memory unit, a long-term memory unit, or other suitable memory units or storage units. Memory 62 may be or may include a plurality of possibly different memory units. Memory 62 may store for example, instructions to carry out a method (e.g., code 64), and/or data such as user responses, interruptions, etc.

Executable code 64 may be any executable code, e.g., an application, a program, a process, task or script. Executable code 64 may be executed by controller 63 possibly under control of operating system 61. For example, executable code 64 may when executed cause the production or compilation of computer code, or application execution such as VR execution or inference, according to embodiments of the present invention. Executable code 64 may be code produced by methods described herein. For the various modules and functions described herein, one or more computing devices and/or components of controller(s) 60 may be used. Devices that include components similar or different to those included in controller(s) 60 may be used and may be connected to a network and used as a system. One or more processor(s) 63 may be configured to carry out embodiments of the present invention by for example executing software or code.

Storage 65 may be or may include, for example, a hard disk drive, a floppy disk drive, a Compact Disk (CD) drive, a CD-Recordable (CD-R) dlive, a universal serial bus (USB) device or other suitable removable and/or fixed storage unit. Data such as instructions, code, VR model data, parameters, etc. may be stored in a storage 65 and may be loaded from storage 65 into a memory 62 where it may be processed by controller 63. In some embodiments, some of the components shown in FIG. 4 may be omitted.

Input devices 66 may be or may include for example a mouse, a keyboard, a touch screen or pad or any suitable input device. It will be recognized that any suitable number of input devices may be operatively connected to controller(s) 60 as shown by block 66. Output devices 67 may include one or more displays, speakers and/or any other suitable output devices. It will be recognized that any suitable number of output devices may be operatively connected to controller(s) 60 as shown by block 67. Any applicable input/output (I/O) devices may be connected to controller(s) 60, for example, a wired or wireless network interface card (NIC), a modem, printer or facsimile machine, a universal serial bus (USB) device or external hard drive may be included in input devices 66 and/or output devices 67.

Embodiments of the invention may include one or more article(s) (e.g., memory 62 or storage 65) such as a computer or processor non-transitory readable medium, or a computer or processor non-transitory storage medium, such as for example a memory as disclosed herein, a disk drive, or a USB flash memory, encoding, including or storing instructions, e.g., computer-executable instructions, which, when executed by a processor or controller, carry out methods disclosed herein.

Elements from FIGS. 1A-4 may be combined in any operable combination, and the illustration of certain elements in certain figures and not in others merely serves an explanatory purpose and is non-limiting.

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram or portions thereof.

These computer program instructions may also be stored in a computer readable medium that can direct a computer, other programmable data processing apparatus, or other devices to function in a pailicular manner, such that the instructions stored in the computer readable medium produce an article of manufacture including instructions which implement the function/act specified in the flowchart and/or portion diagram or pol lions thereof.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram or portions thereof.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1-20. (canceled)

21. An AI (artificial intelligence)-based method of communicating with residents with respect to rent collection, the method comprising:
analyzing payment records associated with managed residents and deriving payment behaviors of the residents,
deriving corresponding message sequences related to the derived payment behaviors, and with respect to a specified collection timeline and specified collection rules, and
sending messages and interactively corresponding with the residents to promote rent payments—according to the derived message sequences and with respect to responses received from the residents,
wherein the derived message sequences and the interactive messaging are specific to individual residents,
wherein the method is carried out to communicate with at least hundreds or thousands of residents simultaneously, and
wherein at least one of the analyzing, the deriving and the sending is carried out at least partially by at least one computer processor.

22. The AI-based method of claim 21, wherein the specified collection timeline includes dates for due payments, grace periods, late fees and legal proceedings, and the specified collection rules include exceptions to the specified collection timeline.

23. The AI-based method of claim 21, further comprising suggesting and following up the execution of payment plans for specific residents, and providing corresponding expected payment data.

24. The AI-based method of claim 21, further comprising adjusting contents and tone of the messages with respect to the analyzed payment records and with respect to the received responses, and further comprising escalating the tone and increasing a frequency of the messages upon non-payment and/or according to the specified collection rules.

25. The AI-based method of claim 21, further comprising using a generative AI (artificial intelligence) model for interacting with the residents by messages, providing explanatory comments concerning a payment balance of the specific resident, wherein the generative AI model is restricted by specified proper language rules.

26. The AI-based method of claim 21, further comprising generating and displaying cyclic collection reports that provide data indicating a rent collection speed and remaining debt in the following month, as well as alerts concerning non-payments.

27. The AI-based method of claim 21, further comprising reducing the total number of messages sent to residents by at least 5% and/or to increase collection of unpaid rent by at least 30%—with respect to rent collection carried out manually.

28. A method of improving rent collection by a property management company and reducing evictions of residents managed thereby, the method comprising:
analyzing payment records associated with managed residents and deriving payment behaviors of the residents,
deriving corresponding message sequences related to the derived payment behaviors, and with respect to a specified collection timeline and specified collection rules, and
sending messages and corresponding interactively with the residents to promote rent payments—according to the derived message sequences and with respect to responses received from the residents,
wherein the derived message sequences and the interactive messaging are specific to individual residents,
wherein rent collection is increased and eviction rate is decreased by tailoring the correspondence to the deriving payment behaviors of the residents and to the responses received from the residents,
wherein at least one of the analyzing, the deriving and the sending is carried out at least partially by at least one computer processor, and
wherein the total number of messages sent to residents is reduced by at least 5% and/or collection of unpaid rent is increased by at least 30%—with respect to rent collection carried out manually.

29. The method of claim 28, wherein the specified collection timeline includes dates for due payments, grace periods, late fees and legal proceedings, and the specified collection rules include exceptions to the specified collection timeline.

30. The method of claim 28, further comprising suggesting and following up the execution of payment plans for specific residents, and providing corresponding expected payment data.

31. The method of claim 28, further comprising adjusting contents and tone of the messages with respect to the analyzed payment records and with respect to the received responses, and further comprising escalating the tone and increasing a frequency of the messages upon non-payment and/or according to the specified collection rules.

32. The method of claim 28, further comprising implementing a generative AI (artificial intelligence) model for interacting with the residents by messages, providing explanatory comments concerning a payment balance of the specific resident, wherein the generative AI model is restricted by specified proper language rules.

33. The method of claim 28, further comprising generating and displaying cyclic collection reports that provide data indicating a rent collection speed and remaining debt in the following month, as well as alerts concerning non-payments.

34. The method of claim 33, further comprising configuring a GUI (graphical user interface) to display the reports and the alerts to the property management company, receiving therefrom approvals and denials for resident-specific exceptions, and further interacting with the residents accordingly.

35. A method of using AI (artificial intelligence) to improve a rent collection system, the method comprising:
training and implementing an interactive message generator to correspond with residents in respect to rent collection by a property management company, by:
engaging the residents according to predefined message sequences, derived with respect to payment behaviors by the individual residents, and with respect to a specified collection timeline and specified collection rules,
corresponding with the residents implementing AI to promote rent collection according to the predefined message sequences and with respect to responses received from the residents,
using AI to derive insights and scoring concerning the residents and alerting the property management company in cases of non-payment, and
deriving AI-based decisions, optionally assisted by human guidance, concerning resolution of payment conflicts, to increase rent collection and reducing resident evictions,
wherein AI training is carried out at least partially by at least one computer processor.

36. The method of claim 35, further comprising deriving the predefined message sequences by continuous machine learning of payment behaviors by the residents, based on ledger data and on collected correspondence of the residents with the interactive message generator.

37. The method of claim 35, further comprising adjusting the correspondence with the residents with respect to contents, tone and degree of required escalation with respect to the specified collection timeline and specified collection rules.

38. The method of claim 37, further comprising escalating the tone and increasing a frequency of the messages upon non-payment and/or according to the specified collection rules.

39. The method of claim 38, further comprising restricting the correspondence by specified proper language rules.

40. The method of claim 35, further comprising generating and displaying cyclic collection reports that provide data indicating a rent collection speed and remaining debt in the following month, as well as alerts concerning non-payments.
